(19) United States
(12) Patent Application Publication
(10) Pub. No.: US 2013/0229957 A1
(43) Pub. Date: Sep. 5, 2013

(54) System and Method For Device-To-Device Communication

(71) Applicants: Philippe Sartori, Algonquin, IL (US); Deping Liu, Schaumburg, IL (US)

(72) Inventors: Philippe Sartori, Algonquin, IL (US); Deping Liu, Schaumburg, IL (US)

(73) Assignee: FutureWei Technologies, Inc., Plano, TX (US)

(21) Appl. No.: 13/410,237

(22) Filed: Mar. 1, 2012

(51) Int. Cl. H04W 72/04; H04J 1/02

(52) U.S. Cl. 370/281

(57) ABSTRACT

Various methods of dynamically allocating resources to user equipments in a DMC group are provided. By way of example, some methods dynamically allocate resources to user equipments in a DMC group in a manner that avoids interfering with user equipments outside the DMC group. Other methods dynamically allocate resources to user equipments in a DMC group in a manner that specifically identifies which of the user equipments in the DMC group is authorized to transmit and which are required to receive.

### TECHNICAL FIELD

The present disclosure relates generally to a system and method for digital communications, and more particularly to a system and method for operations enabling direct mobile communications in a wireless communication system.

### BACKGROUND

In the field of wireless communication, there has been increasing demand for direct device-to-device communication (D2D), direct mobile communication (DMC), and the like. This form of communication refers to a communication mode between two or more user equipments (UEs) that does not include or does not always include a communications controller in a communication path between or among the UEs. DMC will be used herein to denote this form of communication. Generally, DMC communications involve direct communications between multiple DMC devices (the DMC devices are commonly referred to as a UE, a mobile station, a communications device, a subscriber, a terminal, and the like). DMC communications occur as point-to-point (PTP) communications, either point-to-single-point or point-to-multipoint, without having the communications passing through and being fully controlled by a communications controller, such as an evolved NodeB (eNB), a NodeB, a base station, a controller, a communications controller, and the like.

A DMC link is different than a cellular link. A cellular link between UEs involves the data shared between the UEs transiting through a network infrastructure node such as an eNB, relay node, or the like. Note, however, that for a DMC link, while data is directly exchanged between the UEs, the control information for the DMC link may still transit through a network node. DMC can enable a cellular network to offload a portion of its base station traffic. In addition to offloading base-station traffic, DMC also enables proximity-based advertisement for local business entities, which can be a revenue source for such entities. DMC can also enable an end user of a user equipment to find and identify nearby friends. Ad hoc-type services can also be provided among user equipments that are physically near each other. DMC is also a key enabler of local social networking.

There are two main ways of implementing DMC communication, namely a device-centric arrangement and a network-centric arrangement. In the device-centric arrangement, DMC communication takes place without network oversight. However, in the network-centric arrangement the network initiates DMC communication between UEs when conditions (e.g., the proximity of UEs, overall traffic demand, the location of non-DMC UEs, etc.) are appropriate and supports the DMC communication by, for example, transmitting control information, allocating resources, and the like. The network-centric arrangement offers potential for offloading local traffic from the network, which is attractive to cellular operators. Note that while fully device-centric and fully network-centric can be used, in practice, the solution chosen for a DMC deployment may simultaneously use features of both approaches.

### SUMMARY OF THE DISCLOSURE

Embodiments of the present disclosure provide methods of dynamically allocating resources for DMC communication.

In accordance with an example embodiment, a method of allocating resources to user equipments (UEs) in a Direct Mobile Communication (DMC) group. The method includes informing the UEs in the DMC group of a set of UEs outside the DMC group and assigning transmission resources for the set of UEs outside the DMC group. The method also includes assigning potential transmission resources for the DMC group and transmitting a resource allocation to the set of UEs outside the DMC group. The resource allocation indicates that the transmission resources and the potential transmission resources are the same.

In accordance with another example embodiment, a method of allocating resources to user equipments (UEs) in a Direct Mobile Communication (DMC) group. The method includes receiving from a base station an identification of a set of UEs outside the DMC group and receiving an allocation of transmission resources for the set of UEs outside the DMC group. The method also includes using the allocation of transmission resources for communication with other UEs in the DMC group.

In accordance with another example embodiment, a method of allocating resources to user equipments (UEs) in a Direct Mobile Communication (DMC) group. The method includes assigning, for the UEs in the DMC group, identifications for transmission. The method also includes informing the UEs in the DMC group of the identifications and transmitting to the UEs in the DMC group an assignment identified by the identifications assigned. The assignment includes a downlink control indicator (DCI) and the identifications informing UEs in the DMC group of a transmitting UE and a receiving UE.

In accordance with another example embodiment, a method of allocating resources to user equipments (UEs) in a Direct Mobile Communication (DMC) group. The method includes receiving from a base station identities of UEs in the DMC group. The method also includes receiving an assignment based on the identities of UEs in the DMC group and preparing to transmit or receive based on the assignment. The assignment includes a downlink control indicator (DCI).

In accordance with another example embodiment, an apparatus for allocating resources to user equipments (UEs) in a Direct Mobile Communications (DMC) group. The apparatus includes a transmitter, a receiver, and a processor operably coupled to the transmitter and to the receiver. The processor is configured to identify, for the UEs in the DMC group, an allocation of resources accounting for a UE outside the DMC group and to inform the UEs in the DMC group which of the resources may be used by the UEs in the DMC group to engage in DMC communication.

In accordance with another example embodiment, an apparatus for dynamically allocating resources to user equipments (UEs) in a Direct Mobile Communications (DMC) group. The apparatus includes a transmitter, a receiver, and a processor operably coupled to the transmitter and to the receiver. The processor is configured to receive an identification of an allocation of resources accounting for a UE outside the DMC group and to initiate DMC communication based on the allocation of resources.

In accordance with another example embodiment, a method of allocating resources to user equipments (UEs) in a Direct Mobile Communications (DMC) group. The method includes establishing a common group identification for the UEs in the DMC group and assigning a sub-identification unique to each of the UEs in the DMC group. The method also includes placing the sub-identification of one of the UEs in a field of downlink control information (DCI) to indicate that the one of the UEs is authorized to transmit and generating a cyclical redundancy check (CRC) using the DCI and masking the CRC with the common group identification. The method further includes transmitting the DCI and the masked CRC in a channel assignment that, when received and de-masked by each of the UEs in the DMC group, permits the UEs in the DMC group to determine if they have been allocated resources and, if so, identifies that the one of the UEs is authorized to transmit based on the sub-identification placed in the field of the DCI.

In accordance with another example embodiment, a method of dynamically allocating resources to user equipments (UEs) in a Direct Mobile Communication (DMC) group. The method includes receiving a common group identification identifying the UEs in the DMC group and receiving a sub-identification uniquely identifying each of the UEs in the DMC group. The method also includes receiving a channel assignment including downlink control information (DCI) and a masked cyclical redundancy check (CRC) and de-masking the masked CRC using the common group identification to generate a received CRC. The method further includes generating a new CRC using the DCI and comparing the received CRC with the new CRC and, if there is a match, receiving an allocation of resources and an identification of which of the UEs in the DMC group is authorized to transmit based on the sub-identification in the field of the DCI.

In accordance with another example embodiment, a method of allocating resources to user equipments (UEs) in a Direct Mobile Communication (DMC) group. The method includes establishing a group identification for each of the UEs in the DMC group. The group identification includes a first portion common to the DMC group and a second portion unique to each of the UEs in the DMC group. The method also includes identifying one of the UEs as authorized to transmit and generating a cyclical redundancy check (CRC) using downlink control information (DCI) and masking the CRC with the group identification for each of the UEs in the DMC group. The method further includes transmitting the DCI and the masked CRCs in channel assignments that, when received and de-masked by each of the UEs in the DMC group, permit the UEs to determine if they have been allocated resources and, if so, to identify the one of the UEs authorized to transmit based on the second portion of the group identification.

In accordance with another example embodiment, a method of dynamically allocating resources to user equipments (UEs) in a Direct Mobile Communication (DMC) group. The method includes receiving a group identification. The group identification includes a first portion common to the DMC group and a second portion unique to each of the UEs in the DMC group. One of the second portions identifies one of the UEs as authorized to transmit. The method also includes receiving channel assignments including downlink control information (DCI) and masked cyclical redundancy checks (CRCs) and de-masking the masked CRCs using the group identification to generate received CRCs. The method further includes generating a new CRC using the DCI and comparing the received CRCs with the new CRC and, if there is a match, receiving an allocation of resources and an identification of which of the UEs in the DMC group is authorized to transmit based on the second portion of the group identification.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a simplified schematic illustrating a group of UEs engaging in DMC communication, a base station (e.g., an eNB), and a distant UE in accordance with an embodiment;

FIG. 2 is a flowchart illustrating an embodiment of a method of dynamically allocating resources of the distant UE of FIG. 1 to the UEs in the DMC group;

FIG. 3 is a flowchart illustrating another embodiment of a method of dynamically allocating resources of the distant UE of FIG. 1 to the UEs in the DMC group;

FIG. 4 is a flowchart illustrating another embodiment of a method of dynamically allocating resources other than those of the distant UE of FIG. 1 to the UEs in the DMC group;

FIG. 5 is a flowchart illustrating another embodiment of a method of dynamically allocating resources other than those of the distant UE of FIG. 1 to the UEs in the DMC group;

FIG. 6 is a flowchart illustrating an embodiment of a method of dynamically allocating resources to the UEs in the DMC group using a field in downlink control information (DCI) and a masking of a cyclical redundancy check (CRC);

FIG. 7 is a simplified schematic illustrating the process of DMC communication according to FIG. 6;

FIG. 8 is a flowchart illustrating another embodiment of a method of dynamically allocating resources to the UEs in the DMC group using the field in the DCI and the masking of the CRC;

FIG. 9 is a simplified schematic illustrating the process of DMC communication according to FIG. 8;

FIG. 10 is a flowchart illustrating an embodiment of a method of dynamically allocating resources to the UEs in the DMC group using a group identification;

FIG. 11 is a simplified schematic illustrating the process of DMC communication according to FIG. 10;

FIG. 12 is a flowchart illustrating another embodiment of a method of dynamically allocating resources to the UEs in the DMC group using the group identification;

FIG. 13 is a simplified schematic illustrating the process of DMC communication according to FIG. 12;

FIG. 14 is a block diagram of elements of a processing system, such as one of the UEs, that may be used to perform one or more of the methods disclosed herein; and

FIG. 15 is a block diagram of elements of a processing system, such as the eNB, that may be used to perform one or more of the methods disclosed herein.

### DETAILED DESCRIPTION OF ILLUSTRATIVE EMBODIMENTS

The making and using of the presently preferred embodiments are discussed in detail below. It should be appreciated, however, that the present disclosure provides many applicable inventive concepts that can be embodied in a wide variety of specific contexts. The specific embodiments discussed herein are merely illustrative and do not limit the scope of the present disclosure.

As will be more fully explained below, several processes to dynamically allocate resources, both in time and frequency, to a group of user equipments (UEs) engaging in direct-mobile-communication (DMC) are introduced herein.

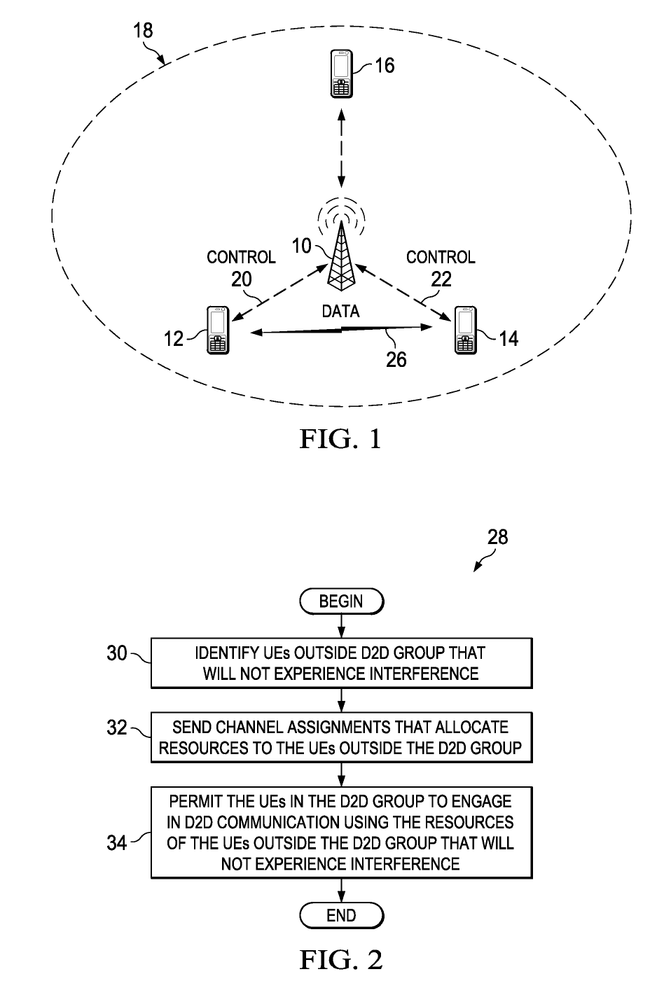

Referring now to FIG. 1, a base station 10, a first DMC UE 12, a second DMC UE 14, and a cellular UE 16 are illustrated within a served area 18. The base station 10, which may be an evolved node B (eNB) or other network infrastructure, communicates control information with the first DMC UE 12 over uplink/downlink wireless communication link 20 and with the second DMC UE 14 over uplink/downlink wireless communication link 22. Likewise, the base station 10 communicates control information with the cellular UE 16 over uplink/downlink wireless communication link 24. The DMC UEs are referred to as a DMC group. A DMC group may comprise two or more DMC UEs. Cellular UE 16 communicates using the base station and, as such, is not part of the DMC group. As will be more fully explained below, when conditions are appropriate the first DMC UE 12 and the second DMC UE 14 are permitted to communicate directly with each other over DMC link 26.

While only a pair of DMC UEs 12, 14, which may be collectively referred to herein as the DMC group, are illustrated in FIG. 1, more DMC UEs may be included in the DMC group and participate in DMC communication. Indeed, DMC communication may either be a single link with only two devices communicating, as shown in FIG. 1, or a multi-link, with multiple devices engaged in DMC. While embodiments are discussed herein utilize single-link DMC communication, multi-link DMC communication may also be used. For instance, many users may set up a local multi-point DMC group as a local social network, for example, group-chatting within a high school, enabling the ability of several persons to play games, or exchanging files by participants in a meeting. The processes introduced herein are targeted to allocate resources for both multi-link and single-link DMC. Communication resources are allocated efficiently for multiple UEs without excluding single-link UE pairs with high performance. In the following, a DMC group is taken as an example without losing commonality.

In addition to the above, while a single cellular UE 16 is illustrated in FIG. 1, more cellular UEs may be present in the served area 18. Indeed, the processes introduced herein are able to accommodate a plurality of cellular UEs for both single-link and multi-link communication. In other words, the methods disclosed are applicable when numerous cellular UEs are found in the served area 18 and communicating with base station 10.

In order to keep UE complexity low, a half frequency-division-duplex (“FDD”) communication protocol for the DMC link is assumed, such as in the uplink band of a Third Generation Partnership Program (“3GPP”) Long Term Evolution (“LTE”) system. Although FDD protocol is described, time-division-duplex (“TDD”) communication protocol can also be used for DMC. Although described with DMC using uplink spectrum, the concepts disclosed herein may also be deployed using downlink spectrum. Use of the uplink band implies that when one DMC UE is transmitting, the other DMC UEs should be prepared to receive. For the purpose of correctly transmitting and receiving a packet, the UEs involved in a DMC group (single-link or multiple-link) are informed when (e.g., the time resources), where (e.g., the frequency resources), and how (e.g., the related Hybrid Automatic Repeat reQuest (HARQ) procedure, modulation and coding scheme (“MCS”), power, and multi-input/multi-output (“MIMO”) scheme) to transmit and receive. To address, for example, the “when” and “where” aspects of DMC communication, resources may be dynamically allocated as described herein.

Referring now to FIG. 2, a method 28 of dynamically allocating resources to the DMC UEs 12, 14 of FIG. 1 is illustrated. In block 30, the cellular UE 16 of FIG. 1, which is outside the DMC group and will not experience interference when the user equipments in the DMC group engage in DMC communication, is identified by the base station 10 for the DMC UEs 12, 14. The cellular UE 16 may not experience interference when the DMC UEs 12, 14 engage in DMC communication due to, for example, the distance between the cellular UE 16 and the DMC UEs 12, 14. Other factors may also prevent the cellular UE 16 from experiencing an undesirable amount of interference when the DMC UEs 12, 14 engage in DMC communication.

In some embodiments, the base station 10 periodically or repeatedly identifies the UEs outside the DMC group (e.g., UE 16) that will not experience interference when the DMC UEs 12, 14 engage in DMC communication. This identification may be at least partly based on signal strength measurements. While described with the level of interference experienced by UEs outside of the group, the base station may identify the target UEs based on other criteria, such as traffic demand, location, and so forth. As such, a list of cellular UEs received or solicited by the DMC UEs 12, 14 is updated from time to time and is not static.

Still referring to FIG. 2, in block 32 the base station 10 of FIG. 1 transmits channel assignments that, among other things, allocate resources to the cellular UE 16. Such resources may include, for example, time information pertaining to a subframe or a series of subframes, frequency information for a radio frame, etc., or some combination thereof. The channel assignments may be sent via a physical downlink control channel (PDCCH), an enhanced physical downlink control channel (ePDCCH), or radio resource control (RRC) signaling. In some embodiments, the channel assignments for the UEs outside the DMC group are sent in a common search space of a channel assignment. In some embodiments, the channel assignments for the user equipments outside the DMC group are sent in a single user equipment specific search space of the PDCCH or the ePDCCH.

In block 34, the DMC UEs 12, 14 are permitted to engage in DMC communication using the resources of the cellular UE 16, which the base station 10 identified as a UE that would not experience interference when the DMC UEs 12, 14 engage in DMC communication. In some embodiments, the base station 10 authorizes one of the DMC UEs 12, 14 to transmit using techniques such as having the DMC UEs take turns, using a predetermined order, or using techniques described in a reference of time domain allocation. In an embodiment, each UE in the DMC group may be linked to a different set of cellular UEs for the authorization of transmission. So, when a UE monitors the channel assignments for the UEs in its corresponding set, it will transmit as instructed. The UEs in the DMC group should be informed of the sets of cellular UEs of each other. Therefore, the other DMC UEs in the group expect to receive from the DMC UE authorized to transmit.

In some embodiments, the base station 10 transmits a common group identification to identify members of the DMC group and a sub-group identification to authorize one of the UEs in the DMC group to transmit. This way, a DMC UE is uniquely identified by its group ID and sub-group ID. The base station may allocate resources to a group of DMC UEs, and the resource allocation within the group UE may be done using the techniques described in a time resource allocation reference.

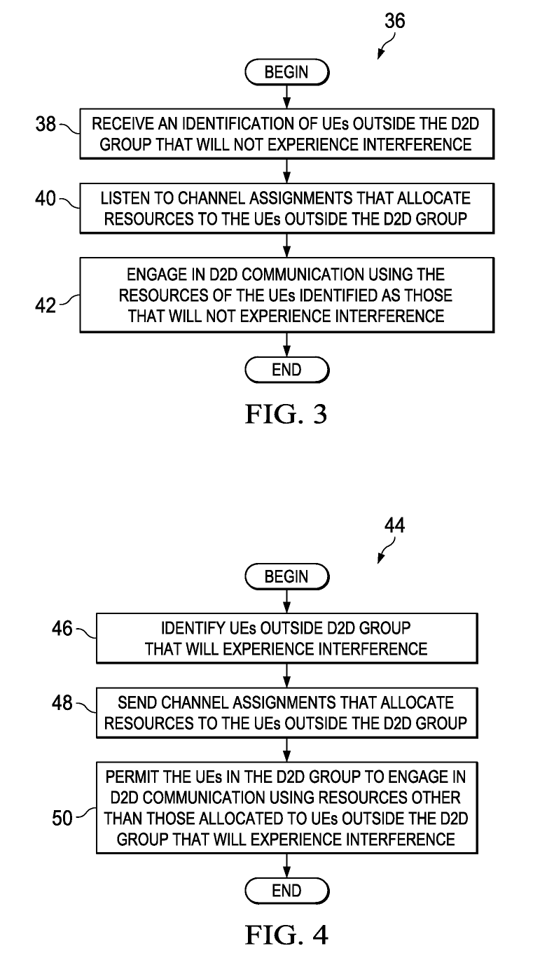

Referring now to FIG. 3, another method 36 of dynamically allocating resources to the DMC UEs 12, 14 is illustrated. In block 38, an identification of one or more cellular UEs, such as the cellular UE 16, which is outside the DMC group and will not experience interference when the user equipments in the DMC group engage in DMC communication, is received by the DMC UEs 12, 14. In block 40, the DMC UEs 12, 14 listen to channel assignments by the base station 10 that allocate resources to the cellular UE 16.

In block 42, the DMC UEs 12, 14 engage in DMC communication using the resources of the cellular UE 16, which the base station 10 identified as a UE that would not experience interference when the DMC UEs engage in DMC communication.

Referring now to FIG. 4, another method 44 of dynamically allocating resources to the DMC UEs 12, 14 is illustrated. Unlike the methods 28, 36 noted above, the DMC UEs 12, 14 in the method 44 are informed of the cellular UEs that will be interfered with if the DMC group engages in DMC communication. Therefore, the DMC UEs in method 44 use resources other than those allocated to the cellular UE 16.

In block 46, the cellular UE 16, which is outside the DMC group and will not experience interference when the user equipments in the DMC group engage in DMC communication, is identified for the DMC UEs 12, 14. In block 48, the base station 10 transmits channel assignments that, among other things, allocate resources to the cellular UE 16.

In block 50, the DMC UEs 12, 14 are permitted to engage in DMC communication using resources other than the resources allocated to the cellular UE 16, which the base station 10 identified as a UE that would experience interference when the DMC UEs 12, 14 engage in DMC communication.

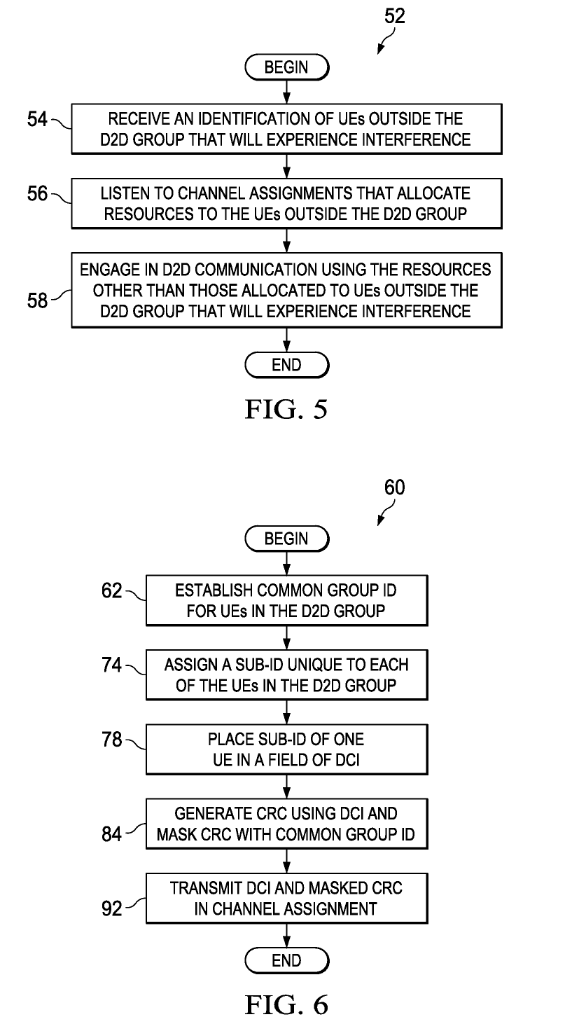

Referring now to FIG. 5, another method 52 of dynamically allocating resources to the DMC UEs 12, 14 is illustrated. In block 54, an identification of the cellular UE 16, which is outside the DMC group and will experience interference when the UEs in the DMC group engage in DMC communication, is received from the base station 10 by the DMC UEs 12, 14. In block 56, the DMC UEs 12, 14 listen to channel assignments by the base station 10 that allocate resources to the cellular UE 16.

In block 58, the DMC UEs 12, 14 engage in DMC communication using resources other than the resources allocated to the cellular UE 16, which the base station 10 identified as a UE that would experience interference when the DMC UEs 12, 14 engage in DMC communication.

For an LTE embodiment, the DMC UEs would need to monitor the ePDCCH or PDCCH to obtain the resource assignments for the corresponding cellular UEs. If they have to monitor PDCCH, the number of blind decodings would be significantly increased since the DMC UEs would need to monitor the entire search spaces of each of the cellular UEs it has to monitor. With an ePDCCH, such a problem may not exist if the UEs to monitor are assigned the same search space. In that case, by monitoring a single search space (the one common to all UEs it has to monitor), the DMC UE will get all the resource assignments.

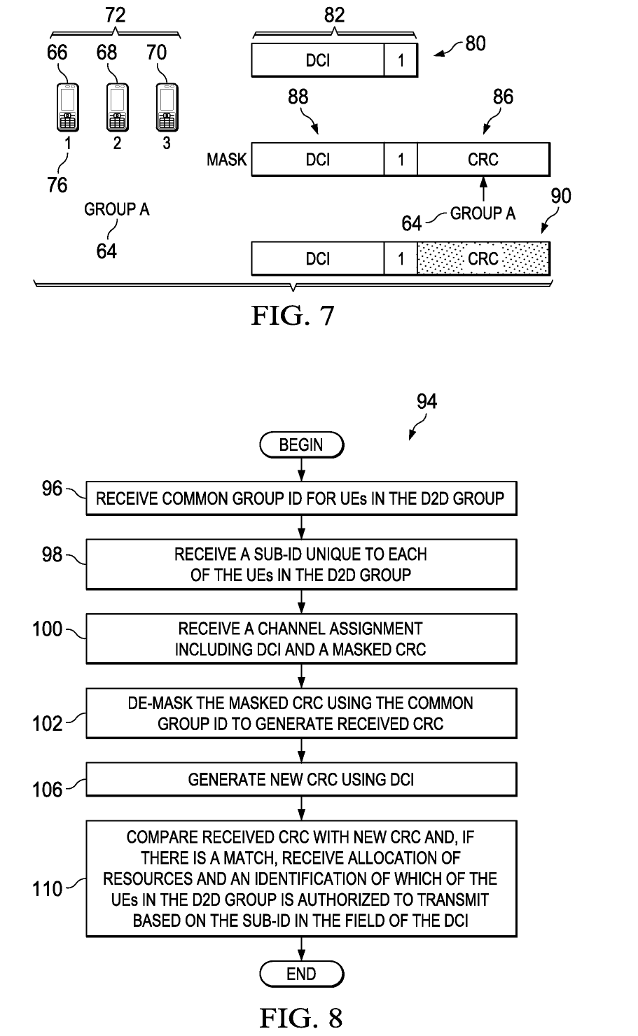

Referring collectively to FIGS. 6-7, another method 60 of dynamically allocating resources to UEs in DMC group is provided. In block 62, a common group identification 64 (FIG. 7) is established for the UEs 66, 68, 70 in the DMC group 72 by, for example, the base station 10. By way of example, the UEs 66, 68, 70 in the DMC group 72 of FIG. 7 are designated as Group A. In block 74 of FIG. 6, a sub-identification 76 (FIG. 7) unique to each of the UEs 66, 68, 70 in the DMC group 72 is assigned by, for example, the base station 10. By way of example, the UEs 66, 68, 70 are individually designated as 1, 2, and 3, respectively (e.g., UE 1, UE 2, UE 3).

In block 78 of FIG. 6, the sub-identification 76 of one of the user equipments 66, 68, 70 is placed in a field 80 (FIG. 7) of downlink control information (DCI) 82 by the base station 10. As shown in FIG. 7, the number “1,” representing the sub-identification 76 assigned to UE 1, is placed in the field 80 of the DCI 82 to indicate that UE 1 is the particular user equipment authorized to transmit. Because the field 80 does not include the number 2 or the number 3, the other UEs in the DMC group 72, namely UE 2 and UE 3, expect to receive information from the DMC authorized to transmit, namely UE 1.

In block 84 of FIG. 6, a cyclical redundancy check (CRC) 86 (FIG. 7) is generated by, for example, the base station 10 using the DCI 82, which includes channel assignment, MCS information, and so on. The DCI 82 and CRC 86 of FIG. 7 generally form a portion of a PDCCH 88 or an enhanced physical downlink control channel (ePDCCH). After the CRC 86 is generated in block 84 of FIG. 6, the CRC 86 is masked by the common group identification 64 of Group A, as shown in FIG. 7, in order to form masked CRC 90. In block 92 of FIG. 6, the DCI 82 and the masked CRC 90 are transmitted in a control channel (e.g., via the PDCCH or the ePDCCH).

As will be more fully explained below, when received and de-masked by each of the UEs 66, 68, 70 in the DMC group 72, the DCI informs the UEs of the resources allocation, and perhaps the modulation coding scheme (MCS) if the system is configured so that the MCS determination is done by the eNB, and so on. If the CRC is correctly checked by de-masking the DMC group ID, then the UEs in the DMC group know the channel assignment is for the group; the DCI identifies UE 1 as the user equipment authorized to transmit based on the sub-identification placed in the field 80 of the DCI 82, and in the meantime, the other UEs in the DMC group are also implicitly informed to be ready to receive.

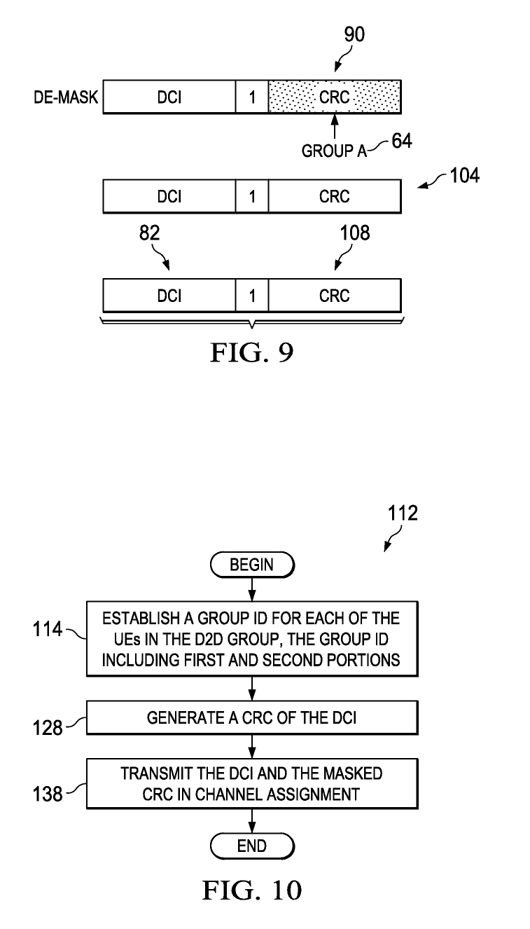

Referring collectively to FIGS. 7-9, the corresponding receiving method 94 of UEs in a DMC group is illustrated. In block 96, the common group identification 64 identifying the UEs 66, 68, 70 in the DMC group 72 is received by the UEs 66, 68, 70 in the DMC group 72. In block 98, a sub-identification uniquely identifying each of the user equipments in the DMC group 72 is received. As shown in FIG. 9, the UEs 66, 68, 70 are individually designated with the sub-identification of “1,” “2,” and “3,” respectively (e.g., UE 1, UE 2, UE 3).

In block 100 of FIG. 8, a control channel including the DCI 82 and the masked CRC 90 shown in FIG. 9 are received by the UEs 66, 68, 70 in FIG. 7. In block 102, the masked CRC 90 is de-masked by the UEs 66, 68, 70 using the common group identification 64 (e.g., Group A) in order to generate a received CRC 104 as shown in FIG. 9. In block 106 of FIG. 8, a new CRC 108 is generated by the UEs 66, 68, 70 using the DCI 82 as shown in FIG. 9. Thereafter, in block 110 of FIG. 8, the received CRC 104 is compared with the new CRC 108. If there is a match, the UEs 66, 68, 70 receive an allocation of resources and an identification of which of the user equipments in the DMC group 72 is authorized to transmit based on the sub-identification in the field 80 of the DCI 82, the other UEs should be prepared to receive according to the DCI 82.

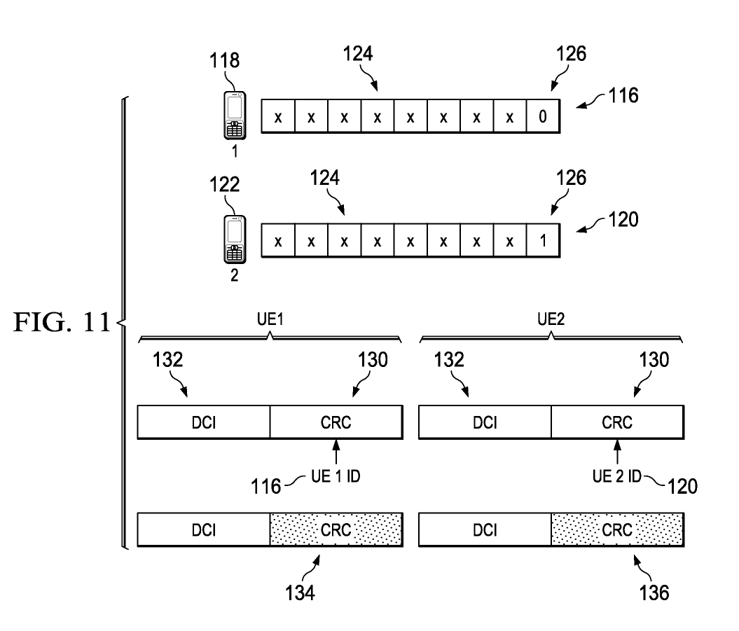

Referring collectively to FIGS. 10-11, another method 112 of dynamically allocating resources to UEs in a DMC group is illustrated. In block 114, an identification 116 is established for UE 118 and an identification 120 is established for UE 122 by the base station 10. By way of example, the identification 116 for UE 1 in FIG. 11 is designated as “xxxxxxxx0” and the identification 120 for UE 2 is designated as “xxxxxxxx1.”

As shown in FIG. 11, each of the identifications 116, 120 includes a first portion 124 (e.g., the “xxxxxxxx”) common to the UEs in the DMC group (e.g., UE 1 and UE 2). Each of the identifications 116, 120 also include a second portion 126 unique to each of the user equipments. In particular, the identification 116 has a second portion of “0” and the identification 120 has a second portion of “1.” As will be more fully explained below, the second portion 126 identifies which of the UEs 118, 122 is authorized to transmit.

In block 128 of FIG. 10, the CRC 130 of the DCI 132 is generated as shown in FIG. 11. Thereafter, and still referring to block 128, the CRC 130 is masked with one of the identifications 116, 120 of the particular one of the UEs 118, 122 in the DMC group. This may form masked CRC 134 for UE 116 and masked CRC 136 for UE 122, which depends who is assigned to transmit. For example, if UE 118 is assigned to transmit, then the CRC of the DCI will be masked with the identification 116 of the particular UE 118. In block 138 of FIG. 10, the DCI 132 and the masked CRC 134 are transmitted to the UEs 118, 122 in a control channel (e.g., the PDCCH or the ePDCCH).

As will be more fully explained below, when received and de-masked by each of the UEs 118, 122 in the DMC group, the DCI 82 informs the UEs 118, 122 of the resource allocation. The identification 116 or identification 120 masked on the CRC will inform the UEs 118, 122 who is permitted to transmit and who should expect to receive. For example, if identification 120 is detected, then the second portion 126 of the identification 120 is a “1.” In this example, UE 122 is supposed to transmit because its identification is masked to the CRC and UE 118 is destined to receive because there is a “0” included in the second portion 126 of its identification 116.

Referring collectively to FIGS. 11-13, another method 140 of dynamically allocating resources to UEs in a DMC group is illustrated. In block 142, the identification 116 is received by UE 118 and identification 120 is received by UE 122. For example, UE 118 receives the identification “xxxxxxxx0” and UE 122 receives the identification “xxxxxxxx1.” As noted above and illustrated in FIG. 11, each of the group identifications 116, 120 includes a first portion 124 (e.g., the “xxxxxxxx”) common to the UEs in the DMC group (e.g., UE 118 and UE 122). Each of the group identifications 116, 120 also includes a second portion 126 unique to each of the user equipments. In particular, UE 118 has a second portion of “0” and UE 122 has a second portion of “1.”

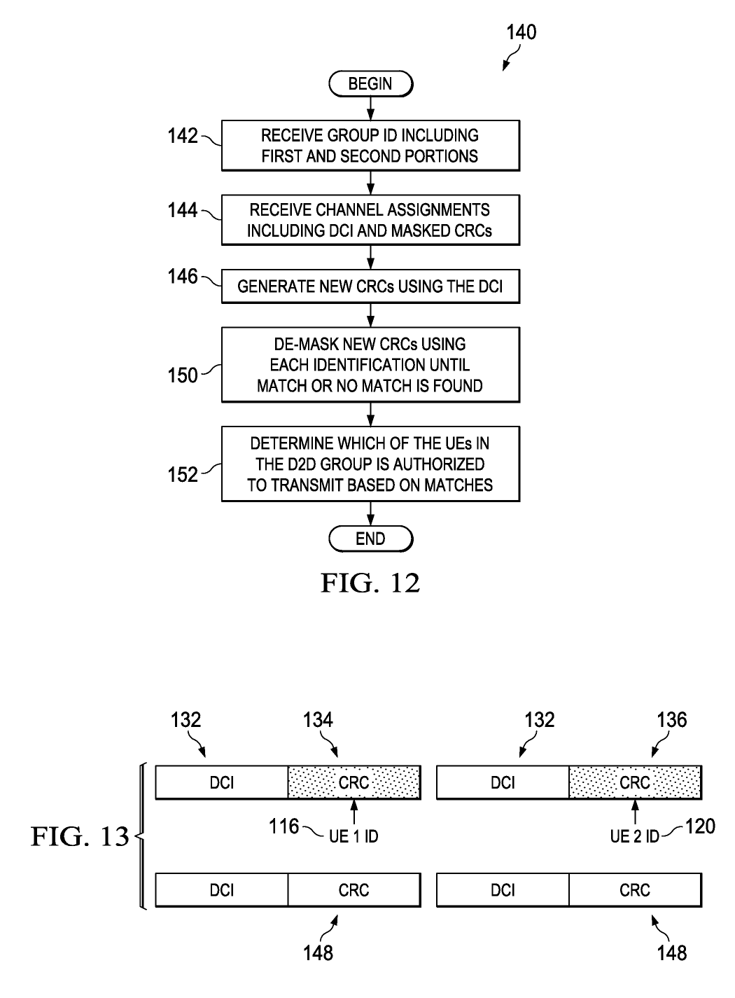

In block 144 of FIG. 12, a channel assignment is received by UE 118 or UE 122 of FIG. 11. The channel assignment includes the DCI 132 and the CRC 134 or 136 masked by identification 116 or 120 of the UEs 118 or 122. In block 146, new CRCs 148 are generated using the DCI 132 (and in an embodiment all other possible parts besides CRC 134 or 136). In block 150, the new CRCs 148 are de-masked using each identification 116, 120 assigned to the DMC group until a matching identification is found or no matching identification is found.

Next, in block 152 of FIG. 12, if there is a matching identification the first portion 124 of the matched identification shows that the DCI 132 is for the UEs in the DMC group. The UE of the exact matched identification in the DMC group is authorized to transmit based on the second portion 126 of the matched identification; the other UEs should be prepared to receive according to the DCI 132. For example, if the matched identification is 116, then UE 118 is supposed to transmit, and UE 122 should be prepared to receive.

The retransmissions can be indicated in the DCI 132 also by a New Data Indicator bit.

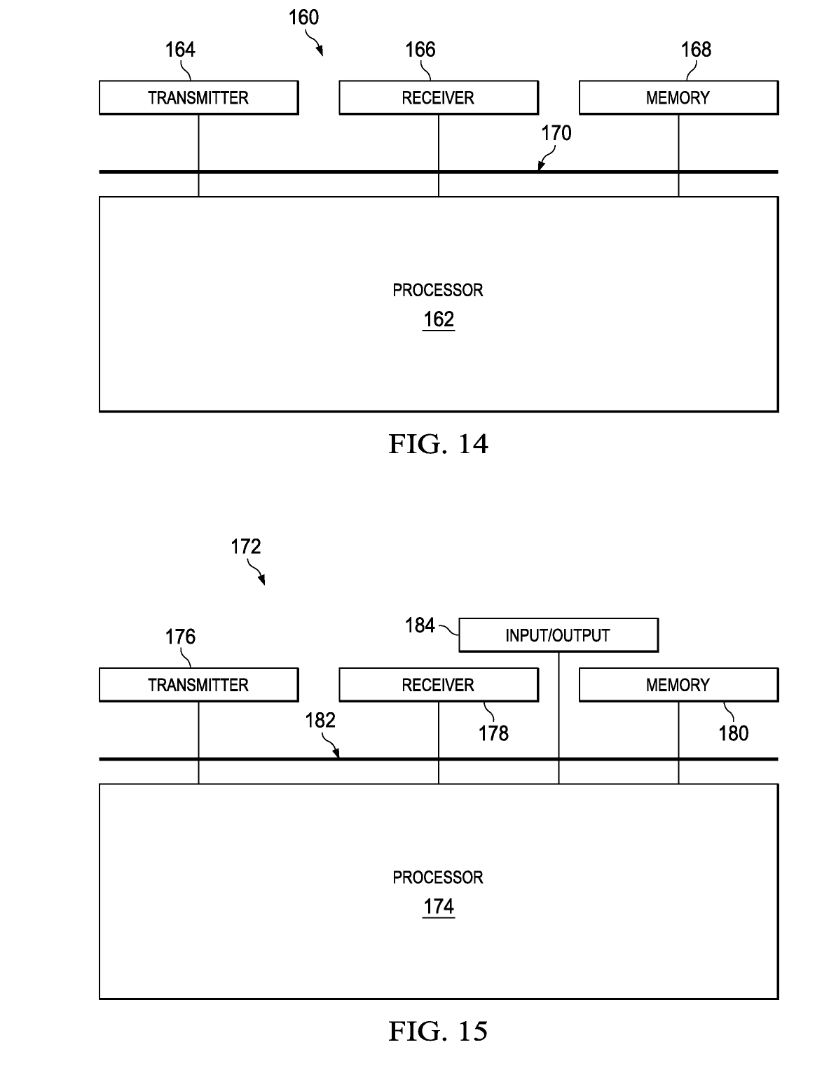

Referring now to FIG. 14, illustrated is a block diagram of elements of a communications device 160, such as an eNB. The communications device 160 may comprise, among other things, a processor 162 that communicates with a transmitter 164, receiver 166, and memory 168 over bus 170. The transmitter 164 and the receiver 166 may be wired, wireless, or both. The memory 168 may include one or more instruction sets or modules that, when executed by the processor 162, perform one or more of the steps or acts in the methods discussed herein.

Referring now to FIG. 15, illustrated is a block diagram of elements of a communications device 172, such as an UE. The communications device 172 may comprise, among other things, a processor 174 that communicates with a transmitter 176, receiver 178, and memory 180 over bus 182. The transmitter 176 and the receiver 178 may be wired, wireless, or both. The memory 180 may include one or more instruction sets or modules that, when executed by the processor 174, perform one or more of the steps or acts in the methods discussed herein. The communications device 172 may also include an input/output device 184 such as, for example, a keyboard, mouse, display, and the like, permitting a user to interface with the communications device 172.

Although embodiments described hereinabove operate within the specifications of a cellular communication network such as a 3GPP-LTE cellular network, other wireless communication arrangements are contemplated within the broad scope of an embodiment, including WiMAX, GSM, Wi-Fi, and other wireless communication systems.

It is noted that, unless indicated otherwise, functions described herein can be performed in either hardware or software, or some combination thereof, with or without human intervention. In an embodiment, the functions are performed by a processor such as a computer or an electronic data processor in accordance with code such as computer program code, software, and/or integrated circuits that are coded to perform such functions, unless indicated otherwise.

While the disclosure has been made with reference to illustrative embodiments, this description is not intended to be construed in a limiting sense. Various modifications and combinations of the illustrative embodiments, as well as other embodiments, will be apparent to persons skilled in the art upon reference to the description. It is therefore intended that the appended claims encompass any such modifications or embodiments.

What is claimed is:

1. A method of allocating resources to user equipments (UEs) in a Direct Mobile Communication (DMC) group, comprising:
informing the UEs in the DMC group of a set of UEs outside the DMC group;
assigning transmission resources for the set of UEs outside the DMC group;
assigning potential transmission resources for the DMC group; and
transmitting a resource allocation to the set of UEs outside the DMC group, the resource allocation indicating that the transmission resources and the potential transmission resources are the same.

2. The method of claim 1, further comprising updating the set of UEs outside the DMC.

3. The method of claim 1, wherein the step of transmitting the resource allocation to the set of UEs outside the DMC group further comprises transmitting the resource allocation to the UEs in the DMC group.

4. The method of claim 1, further comprising indicating that the UEs in the DMC group may use the transmission resources assigned to the set of UEs outside the DMC group.

5. The method of claim 1, further comprising transmitting the resource allocation using radio resource control signaling.

6. The method of claim 1, further comprising transmitting the resource allocation using a control channel.

7. The method of claim 1, further comprising indicating that the UEs in the DMC group may use the transmission resources other than those assigned to the set of UEs outside the DMC group.

8. The method of claim 1, further comprising sending an identification (ID) of each UE in the set of UEs outside the DMC group to the UEs in the DMC group.

9. The method of claim 8, further comprising using radio resource control signaling.

10. The method of claim 8, further comprising sending the IDs in a common search space.

11. The method of claim 8, further comprising sending the IDs in a search space of each of the UEs within the DMC group.

12. The method of claim 1, further comprising authorizing one of the UEs in the DMC group to transmit to other UEs in the DMC group.

13. A method of allocating resources to user equipments (UEs) in a Direct Mobile Communication (DMC) group, comprising:
receiving from a base station an identification of a set of UEs outside the DMC group;
receiving an allocation of transmission resources for the set of UEs outside the DMC group; and
using the allocation of transmission resources for communication with other UEs in the DMC group.

14. The method of claim 13, wherein the allocation is mapped on a set of common resources.

15. The method of claim 13, wherein the communication is a transmission.

16. The method of claim 13, wherein the communication is a reception.

17. The method of claim 13, further comprising repeating the step of receiving the allocation in order to update the allocation of resources.

18. The method of claim 13, further comprising receiving an indication that the UEs in the DMC group may use the resources of the UE outside the DMC group.

19. The method of claim 13, further comprising receiving an indication that the UEs in the DMC group may use the resources of the UE outside the DMC group.

20. The method of claim 13, further comprising listening for a channel assignment to inform the UEs in the DMC group which of the resources may be used.

21. The method of claim 20, further comprising receiving the channel assignment in a common search space of a control channel.

22. The method of claim 21, wherein the control channel is an enhanced physical downlink control channel (ePDCCH).

23. The method of claim 22, further comprising sending the channel assignment in a search space of a UE.

24. The method of claim 13, further comprising receiving an indication that one of the UEs in the DMC group is authorized to transmit to other UEs in the DMC group.

25. A method of allocating resources to user equipments (UEs) in a Direct Mobile Communication (DMC) group, comprising:
assigning, for the UEs in the DMC group, identifications for transmission;
informing the UEs in the DMC group of the identifications; and
transmitting to the UEs in the DMC group an assignment identified by the identifications assigned, the assignment including a downlink control indicator (DCI) and the identifications informing UEs in the DMC group of a transmitting UE and at least a receiving UE.

26. The method of claim 25, further comprising masking a group identity of the UEs in the DMC group on a CRC of the DCI.

27. The method of claim 26, further comprising including an identity of the transmitting UE in the DCI.

28. The method of claim 25, wherein the identifications for transmission comprise a portion common to all of the UEs in the DMC group and a portion distinct to each of the UEs in the DMC group.

29. The method of claim 28, further comprising masking an identify of the transmitting UE on a CRC of the DCI.

30. The method of claim 25, further comprising the assignment is transmitted on control channel.

31. A method of allocating resources to user equipments (UEs) in a Direct Mobile Communication (DMC) group, comprising:
receiving from a base station identities of UEs in the DMC group;
receiving an assignment based on the identities of UEs in the DMC group; and
preparing to at least one of transmit and receive based on the assignment, the assignment including a downlink control indicator (DCI).

32. The method of claim 31, further comprising de-masking a CRC of the assignment to obtain a group identity of the UEs in the DMC group, the group identity indicating that the assignment is intended for the DMC group.

33. The method of claim 32, further comprising obtaining an identity of a UE authorized to transmit from the DCI in the assignment.

34. The method of claim 31, further comprising recognizing the DMC group by a common portion of an identity masked on a CRC of the assignment.

35. The method of claim 34, further comprising transmitting if an identity of the UE is masked on the CRC of the DCI.

36. The method of claim 35, further comprising receiving if an identity of the UE is not masked on the CRC of the DCI.

37. The method of claim 31, wherein receiving the assignment further comprises receiving the assignment on a control channel.

38. An apparatus for allocating resources to user equipments (UEs) in a Direct Mobile Communications (DMC) group, comprising:
a transmitter;
a receiver; and
a processor operably coupled to the transmitter and to the receiver, the processor configured to identify, for the UEs in the DMC group, an allocation of resources accounting for a UE outside the DMC group and to inform the UEs in the DMC group which of the resources may be used by the UEs in the DMC group to engage in DMC communication.

39. An apparatus for dynamically allocating resources to user equipments (UEs) in a Direct Mobile Communications (DMC) group, comprising:
a transmitter;
a receiver; and
a processor operably coupled to the transmitter and to the receiver, the processor configured to receive an identification of an allocation of resources accounting for a UE outside the DMC group and to initiate DMC communication based on the allocation of resources.

40. A method of allocating resources to user equipments (UEs) in a Direct Mobile Communications (DMC) group, comprising:
establishing a common group identification for the UEs in the DMC group;
assigning a sub-identification unique to each of the UEs in the DMC group;
placing the sub-identification of one of the UEs in a field of downlink control information (DCI) to indicate that the one of the UEs is authorized to transmit;
generating a cyclical redundancy check (CRC) using the DCI and masking the CRC with the common group identification; and
transmitting the DCI and the masked CRC in a channel assignment that, when received and de-masked by each of the UEs in the DMC group, permits the UEs in the DMC group to determine if they have been allocated resources and, if so, identifies that the one of the UEs is authorized to transmit based on the sub-identification placed in the field of the DCI.

41. A method of dynamically allocating resources to user equipments (UEs) in a Direct Mobile Communication (DMC) group, comprising:
receiving a common group identification identifying the UEs in the DMC group;
receiving a sub-identification uniquely identifying each of the UEs in the DMC group;
receiving a channel assignment including downlink control information (DCI) and a masked cyclical redundancy check (CRC);
de-masking the masked CRC using the common group identification to generate a received CRC;
generating a new CRC using the DCI;
comparing the received CRC with the new CRC and, if there is a match, receiving an allocation of resources and an identification of which of the UEs in the DMC group is authorized to transmit based on the sub-identification in the field of the DCI.

42. A method of allocating resources to user equipments (UEs) in a Direct Mobile Communication (DMC) group, comprising:
establishing a group identification for each of the UEs in the DMC group, the group identification including a first portion common to the DMC group and a second portion unique to each of the UEs in the DMC group and identifying one of the UEs as authorized to transmit;
generating a cyclical redundancy check (CRC) using downlink control information (DCI) and masking the CRC with the group identification for each of the UEs in the DMC group;
transmitting the DCI and the masked CRCs in channel assignments that, when received and de-masked by each of the UEs in the DMC group, permit the UEs to determine if they have been allocated resources and, if so, to identify the one of the UEs authorized to transmit based on the second portion of the group identification.

43. A method of dynamically allocating resources to user equipments (UEs) in a Direct Mobile Communication (DMC) group, comprising:
receiving a group identification, the group identification including a first portion common to the DMC group and a second portion unique to each of the UEs in the DMC group, one of the second portions identifying one of the UEs as authorized to transmit;
receiving channel assignments including downlink control information (DCI) and masked cyclical redundancy checks (CRCs);
de-masking the masked CRCs using the group identification to generate received CRCs;
generating a new CRC using the DCI;
comparing the received CRCs with the new CRC and, if there is a match, receiving an allocation of resources and an identification of which of the UEs in the DMC group is authorized to transmit based on the second portion of the group identification.
